(19) United States
(12) Patent Application Publication
(10) Pub. No.: US 2022/0036159 A1
(43) Pub. Date: Feb. 3, 2022

(54) SYSTEM, METHOD AND NETWORK NODE FOR GENERATING AT LEAST ONE CLASSIFICATION BASED ON MACHINE LEARNING TECHNIQUES

(71) Applicants: Zhongwen Zhu, Saint-Laurent (CA); Qinan Qi, Saint-Laurent (CA); Qiang Fan, Montreal (CA)

(72) Inventors: Zhongwen Zhu, Saint-Laurent (CA); Qinan Qi, Saint-Laurent (CA); Qiang Fan, Montreal (CA)

(73) Assignee: TELEFONAKTIEBOLAGET LM ERICSSON (PUBL), Stockholm (SE)

(21) Appl. No.: 17/299,263

(22) PCT Filed: Dec. 7, 2018
(86) PCT No.: PCT/IB2018/059781

§ 371 Date: Jun. 2, 2021

(51) Int. Cl. G06N 3/04; G06N 3/08

(52) U.S. Cl. CPC G06N 3/0454; G06K 9/6267; G06N 3/08

(57) ABSTRACT

The disclosure relates to a system, method, and network node for generating at least one classification based on multiple data sources. The system comprises at least one layer comprising one or more supervised neural networks (SNN); at least one layer comprising one or more unsupervised neural networks (USNN); and at least one normalization layer. Each of the layers has inputs and outputs, the inputs of a first layer being operative to receive data from the data sources, the inputs of a layer other than the first layer being communicatively connected to the outputs of a previous layer, the outputs of a layer other than a last layer being communicatively connected to inputs of a following layer, the last layer having at least one output, and the at least one normalization layer being operative to normalize the outputs from the previous layer into normalized inputs for the following layer.

### TECHNICAL FIELD

The present disclosure relates to supervised and unsupervised machine learning techniques.

### BACKGROUND

Supervised learning is the task of learning a function that maps an input to an output based on example input-output pairs. It infers a function from “labeled” training data consisting of a set of training examples. In supervised learning, each example is a pair consisting of an input object and a desired output value. A supervised learning algorithm analyzes the training data and produces an inferred function, which can be used for mapping new examples.

An optimal scenario would allow for the algorithm to correctly determine the class labels for unseen instances. This requires that the learning algorithm generalizes from the training data to unseen situations in a “reasonable” way.

Unsupervised machine learning is the task of inferring a function that describes the structure of “unlabeled” data (i.e. data that has not been classified or categorized). Since the examples given to the learning algorithm are unlabeled, there is no straightforward way to evaluate the accuracy of the structure that is produced by the algorithm.

With a rapid expansion of networks around the world, the number of connected devices increases significantly. At the same time, the number of applications, and the number of consumers or subscribers for those applications and devices that are connected to the network also increases from month to month. This leads to an exponential growth of the number of activities in the networks.

Due to these activities in the networks, a large amount of data is being generated. This data contains information or intelligence that might be beneficial to our daily life now or in the future.

How to retrieve this intelligence from the massive data available today remains a challenge for human being right now. Furthermore, how to apply the intelligence that can be extracted from this data to our daily life is another challenge.

In the past decades, artificial intelligence (AI) and deep learning have gain momentum due to the evolution of computational power and storage. This has helped us to retrieve intelligence from the data collected. On the other hand, the information technology (IT) software industry also has to gain from advances in software architecture, to have the better and more efficient way to handle the data, such as, collecting and transferring data.

However, these challenges (data modeling with AI, data transferring, data storage and data processing) are still being studied by different research groups, and research and development (R&D) in different industries continues in order to have more accurate data representation and real time control mechanisms.

In this document, a new approach that address both AI data modeling as well as real time control mechanisms is proposed.

### SUMMARY

There is provided a system for generating at least one classification based on multiple data sources. The system comprises at least one layer comprising one or more supervised neural networks (SNN); at least one layer comprising one or more unsupervised neural networks (USNN); and at least one normalization layer. Each of the layers has inputs and outputs, the inputs of a first layer being operative to receive data from the data sources, the inputs of a layer other than the first layer being communicatively connected to the outputs of a previous layer, the outputs of a layer other than a last layer being communicatively connected to inputs of a following layer, the last layer having at least one output, and the at least one normalization layer being operative to normalize the outputs from the previous layer into normalized inputs for the following layer.

The system may comprise at least two layers of SNNs. The system may comprise at least two layers of USNNs. The system may comprise at least two normalization layers. The system may comprise three layers, the first layer comprising SNNs, the second layer being a normalization layer and the last layer comprising USNNs and one SNN. The SNN of the last layer may generate the at least one classification using as inputs the outputs of the USNNs. Each SNN and each USNN may have multiple inputs and each SNN and each USNN may have a single output. Each SNN and each USNN may have multiple inputs and at least one of the SNNs and USNNs may have multiple outputs. The normalization layer may normalize the outputs from the previous layer into normalized inputs for the following layer by matching and replacing the outputs from the previous layer with normalized data stored in a data repository accessible by the normalization layer. The normalization layer may combine a subset of the plurality of outputs from the previous layer in to a single normalized input for the following layer. The normalized data stored in the data repository may be computed using a weighted average, an arithmetic computation or a maximum probability function.

There is provided a method for using a system for generating at least one classification based on multiple data sources. The system comprises at least one layer comprising one or more supervised neural networks (SNN); at least one layer comprising one or more unsupervised neural networks (USNN); and at least one normalization layer. Each of the layers has inputs and outputs, the inputs of a first layer receiving data from the data sources, the inputs of a layer other than the first layer being communicatively connected to the outputs of a previous layer, the outputs of a layer other than a last layer being communicatively connected to inputs of a following layer, the last layer having at least one output, and the at least one normalization layer being operative to normalize the outputs from the previous layer into normalized inputs for the following layer. The method comprises activating the data sources; and obtaining the at least one classification from the at least one output of the last layer. The method may further comprise training the SNNs and USNNs. The method may further comprise computing normalized data, for storing in a data repository accessible by the normalization layer, using a weighted average, an arithmetic computation or a maximum probability function. The method may be executed in a system according to any one of the systems described previously.

There is provided a network node operative to generate at least one classification based on multiple data sources. The network node comprises processing circuitry and a memory. The memory contains instructions executable by the processing circuitry whereby the network node is operative to host a system. The system comprises at least one layer comprising one or more supervised neural networks (SNN); at least one layer comprising one or more unsupervised neural networks (USNN); and at least one normalization layer. Each of the layers has inputs and outputs, the inputs of a first layer being operative to receive data from the data sources, the inputs of a layer other than the first layer being communicatively connected to the outputs of a previous layer, the outputs of a layer other than a last layer being communicatively connected to inputs of a following layer, the last layer having at least one output, and the at least one normalization layer being operative to normalize the outputs from the previous layer into normalized inputs for the following layer. The network node is further operative to activate the data sources; and obtain the at least one classification from the at least one output of the last layer.

There is provided a non-transitory computer readable media having stored thereon instructions for executing any one of the methods described herein.

The system, method and network node provided herein present improvements to the way system, method and network node, which are described in the previous section operate.

### BRIEF DESCRIPTION OF THE DRAWINGS

FIG. 1 is a schematic illustration of a system according to an example embodiment.

FIG. 2 is a schematic illustration showing the training of an USNN and of a SNN in a layer of a system according to an example embodiment.

FIG. 3 is a schematic illustration of an example re-construction of a data representation of a target object in a layer of a system according to an example embodiment.

FIG. 4 is a schematic illustration of a system according to an example embodiment.

FIG. 5 is a schematic illustration of a system for classifying multiple objects at a single location according to an example embodiment.

FIG. 6 is a schematic illustration of a system for classifying a single object at a single location having multiple components according to an example embodiment.

FIG. 7 is a schematic illustration of a system for classifying multiple objects at different locations according to an example embodiment.

FIG. 8 is a schematic illustration of a system deployed at different locations according to an example embodiment.

FIGS. 9-11 are schematic illustrations of a system in use for premises security according to an example embodiment.

FIG. 12-14 are schematic illustrations of a system in use for network monitoring according to an example embodiment.

FIG. 15 is a flowchart of a method according to an example embodiment.

FIG. 16 is a schematic illustration of a network node according to an example embodiment.

FIG. 17 is a schematic illustration of a cloud environment in which embodiments can be deployed.

### DETAILED DESCRIPTION

Various features and embodiments will now be described with reference to the figures to fully convey the scope of the disclosure to those skilled in the art.

Many aspects will be described in terms of sequences of actions or functions. It should be recognized that in some embodiments, some functions or actions could be performed by specialized circuits, by program instructions being executed by one or more processors, or by a combination of both.

Further, some embodiments can be partially or completely embodied in the form of computer readable carrier or carrier wave containing an appropriate set of computer instructions that would cause a processor to carry out the techniques described herein.

In some alternate embodiments, the functions/actions may occur out of the order noted in the sequence of actions or simultaneously. Furthermore, in some illustrations, some blocks, functions or actions may be optional and may or may not be executed; these may be, in some instances, illustrated with dashed lines.

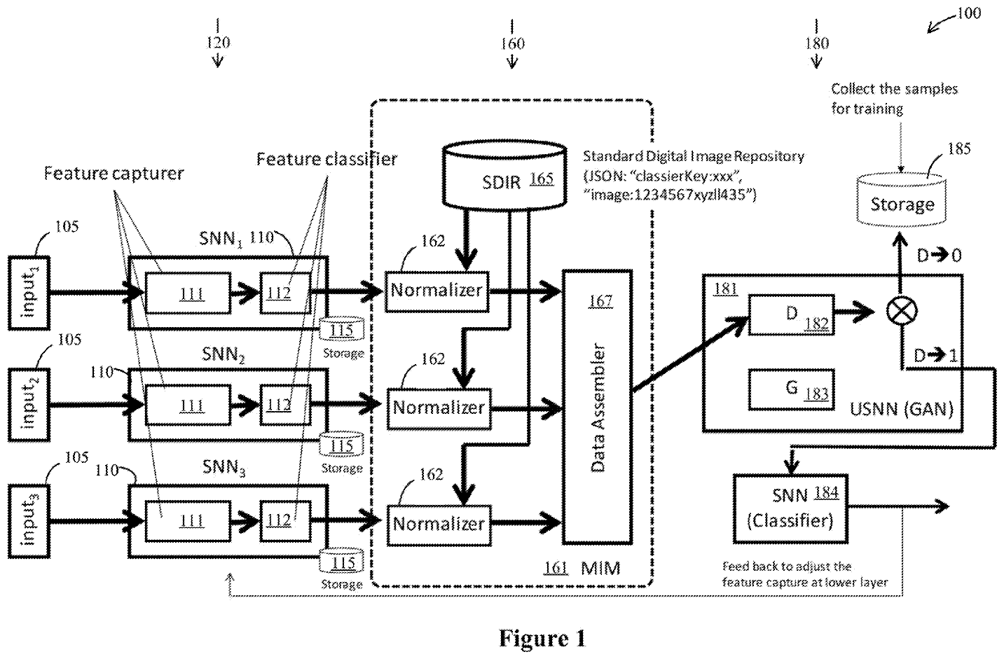

FIG. 1 illustrates a system 100 according to an embodiment. In the context of this specification, first layer, previous layer and lower layer may be used, in some instances, interchangeably, depending on the context, while last layer, following layer, subsequent layer or last layer may be used, in some instances, interchangeably, depending on the context. Further, model, training/trained/learning model and modeling may be used for designating the end result of a learning algorithm, such as a trained supervised or un-supervised neural network or a plurality of trained neural networks that make the system 100.

Although there are only single arrows interconnecting the components of the different layers in FIG. 1, a person skilled in the art would understand that multiple data, in different formats, can move from one layer to another. One arrow could represent, for example, thousands of pixels of an image, a vector of data, a single value, or any other suitable data or data structure. This also applies to similar arrows in the other figures.

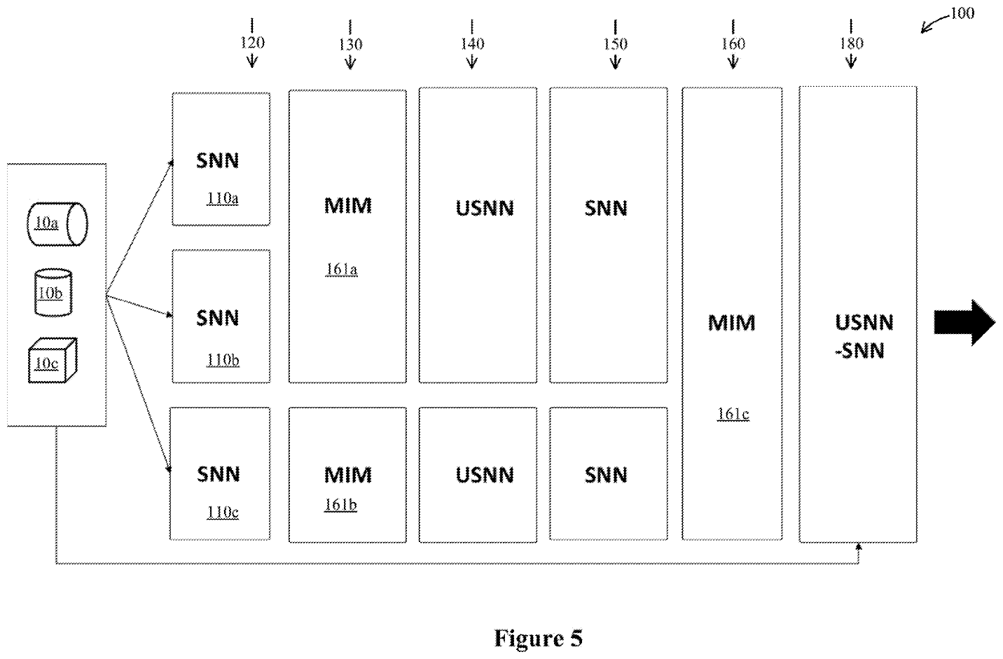

For modeling the system, a combination of both supervised training and un-supervised training models are used. The system 100 has a multiple layer's structure: there is at least a lower layer 120 implementing a training model, and an upper layer 180 implementing a training model. Throughout this disclosure, two layers 120, 180 with training models are used for simplicity and clarity, but it is straightforward to extend this system to more layers (see for example FIGS. 5-7).

At the lower layer 120, a supervised learning using localized data 105 from the sources is applied. This may be done with supervised neural network (SNN) 110. The SNN 110 can be modelized as comprising a feature capturer part 111 and a feature classifier part 112. SNN 110 could also be modelized differently. The data 105 may, for example, have simple data representation and may be easy to classify. Then, the data representations classified in the first layer 120 can be stored in storage 115.

For the application of the trained model in the first layer 120, the output of the local trained model, which may represent a probability for a certain feature, may be captured as a “key feature name”, such as an index. The output may alternatively be a classification, a value or any other suitable data. If an index is used, this index may be sent to the upper layer for further training, via a network.

As described above, the supervised learning model, or SNN, can be used at lower layer based on the assumption that the identification of local data distribution (feature) is relatively easy and affordable.

The level of accuracy of the training model depends upon the size of the “sample area” as well as the resolution of the sample.

The number of SNN at low layer can be adjusted based on the feedback from upper layer, as shown in FIG. 1. The feedback from the upper layer can also be used to update some of the existing SNNs.

The output from the SNN is generally the probability for a certain feature. This information is used to locate the normalized data representation for the identified feature in the storage (memory) 165.

The data representations classified in the first layer 120 may be normalized to have a single data representation for one class (1-1 mapping) in the layer 160. The normalized data representation can be extracted using the principle of Match In Memory (MIM) 161.

The outputs from layer 120 enter normalizers 162, which each fetch, for example, a standard digital image from repository 165. Here, and throughout this disclosure image is not limited to a picture, but can comprise different types of data representations such as value, vector or values, etc. The normalized data representation should be available in the storage 165, but, alternatively, it may be possible to add new data representations at this stage. Any type of normalized data can be stored in data repository 165, and should be appropriate to the application for which this system is used. A data assembler 167 may be present and may assemble the outputs from the normalizers into a single output. Alternatively, many other types of outputs could be generated by the data assembler 167 as would be apparent to the person skilled in the art.

During the SNN training at lower layer, all the data representations (distribution) from training samples for certain features can be normalized to create a standard data representation for each of these features. The normalization can be done through the following algorithms: weighted average, simple arithmetic mean, a data distribution to be selected based on the maximum probability from the classifier, etc. Other normalization algorithms known in the art can be used interchangeably depending on the needs and the context.

The normalized data representations are then stored in the storage 165, which may be called a standard digital image repository (SDIR). These data representations may be retrieved based on an index of the classifier (the SNN) at lower layer.

At the upper layer 180, the normalized data representation may be merged into a single data representation, which is then used as a sample input for un-supervised learning. In the example of FIG. 1, unsupervised learning is done using an un-supervised neural network (USNN) 181, such as Generative Adversarial Network (GAN), with Discriminator (D) 182 and Generator (G) 183 being elements needed for the GAN USNN. Alternatively, the data representation may or may not be merged and other unsupervised learning approaches could be used. In the case where the data is merged, the input data representation from the data assembler 167 (that is constructed based on the normalized data representation for different features) is the input for USNN model and is verified through the USNN to see if a data representation is known or not. Samples for training the network may be stored in storage 185, and another SNN 184 may be used after the USNN(s) for final classification.

In the GAN model shown in the example of FIG. 1, the discriminator D 182 has been trained to differentiate the input data representation between known data representation and unknown data representation. For the unknown data representation (D→0 or D=0), the data is captured in the storage and an alarm or a notification may be issued to indicate or warn the operator to check the system. In this case, the sample can be used for training in the future.

For the known data representation (D→1 or D=1), the data representation is sent to the classifier 184 that has been trained to capture different known scenarios. For each scenario, corresponding actions can be taken.

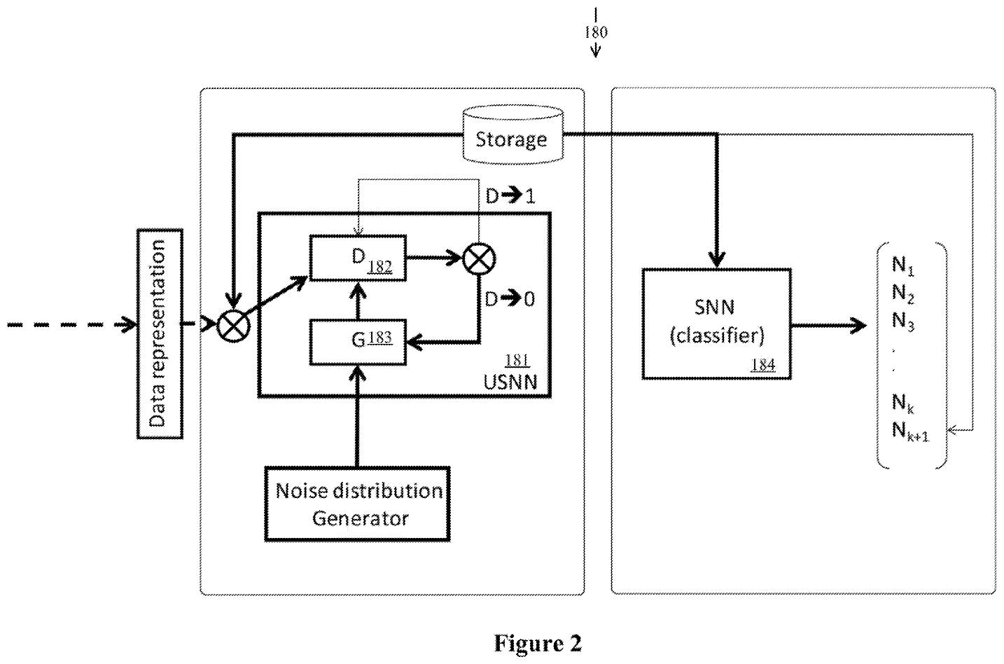

Turning to FIG. 2, two training models are shown. The left block is a USNN 181 based on GAN; the right block is a SNN 184.

In the GAN model, the samples collected in the storage can be used as input data representations. Those samples are considered as true samples. Hence the Discriminator (D) 182 in the GAN produces D→1 for these true samples. At the same time, the data representation created by Generator (G) 183, based on a noise distribution, are considered as fake data representations and D produces D→0 for these noise distributions. Following this guidance, G 183 and D 182 are trained to let D remember the feature given by the true samples only and to catch all the fake samples generated by G. At the same time, G can produce a data representation that captures major features given by the true samples. In some embodiments, D is used for data processing in real time, to locate any new data representations.

The collected samples are also used to train SNN 184 to classify the unknown data representations into new categories, as shown in FIG. 2, such as new category Nₖ₊₁. Then, this modified SNN 184 is applied to the data representations real time processing.

In addition, the output of this training can be used as feedback towards the SNNs at low layers, as was illustrated in FIG. 1.

The different layers, such as lower layer 120, MIM 160 and upper layer 180 might reside in different locations in a network. The output of the upper layer may also be fed back to the lower layer as indicated in FIG. 1.

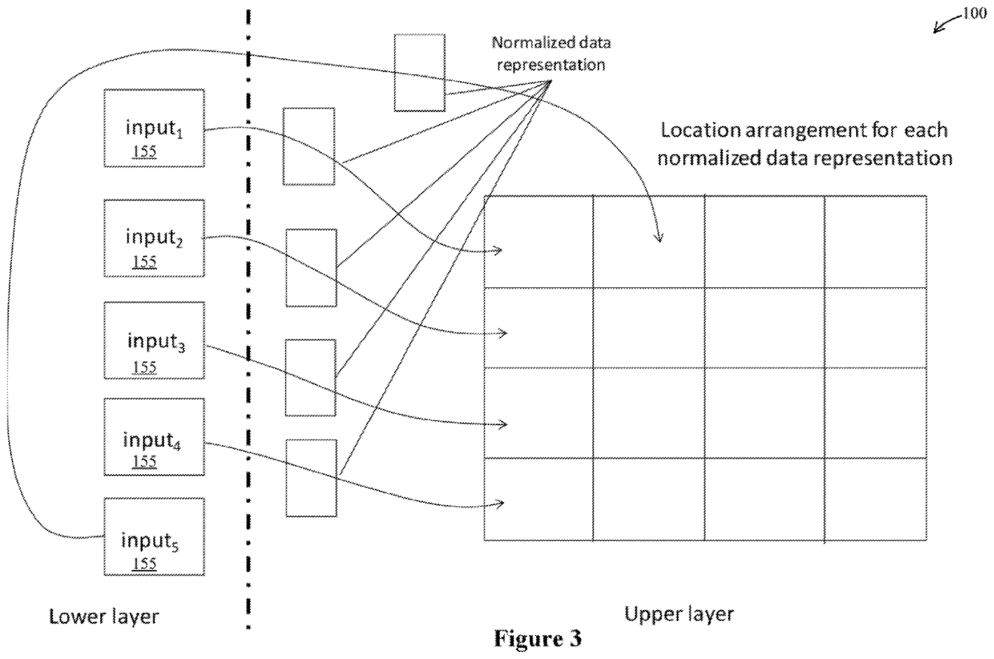

FIG. 3 illustrates a simplified view of a system 100, in which multiple SNNs are designed for recognizing or categorizing certain features at the lower layer. New SNNs can be added in case of a need to capture new features at the lower layer.

When an input sample is feed into a SNN at the lower layer 120, a feature is captured by the model within the SNN, and an output from the SNN or from a classifier is handed over to an upper layer 180. The classifier may be distinct from the SNN or it may be the same. Then, in some embodiments, the upper layer fetches all the normalized features from the storage (using Match-In-Memory) and assembles these normalized features into a single data representation, which forms a sample for the unsupervised training model (USNN) of the upper layer 180.

In FIG. 3, a GAN is used for the USNN. If the data representation is recognized by the GAN (D→1), this data representation is sent to a SNN for the classification since the data is recognized by the existing model. If the data representation is not recognized by GAN (D→0), the data representation is stored in the storage as a sample to be used in the future for un-supervised learning via GAN as well as for SNN for classification. FIG. 3 shows a possible location arrangement for each normalized data representation.

The inputs 155 in FIG. 3 are given by the classifier at lower layer 120. These inputs 155 may be indexes for given features. These indexes or indices are used to retrieve, for example, normalized images from SDIR 165.

The next step in this example is to reconstruct the image based on the retrieved normalized data representation (normalized images). There are many ways to build or reconstruct this image. One example is given in FIG. 3, where each normalized image is arranged from top to bottom, and from left to right. Other examples will be provided using e.g. the location where the samples are taken.

As indicated previously, the output of the upper layer may be used as feedback towards SNNs at low layer. The feedback might lead to adjustment on the features capture in the SNNs.

Different combinations among SNN at lower layer, MIM and USNN at upper layer will be provided to demonstrate the flexibility of the system 100.

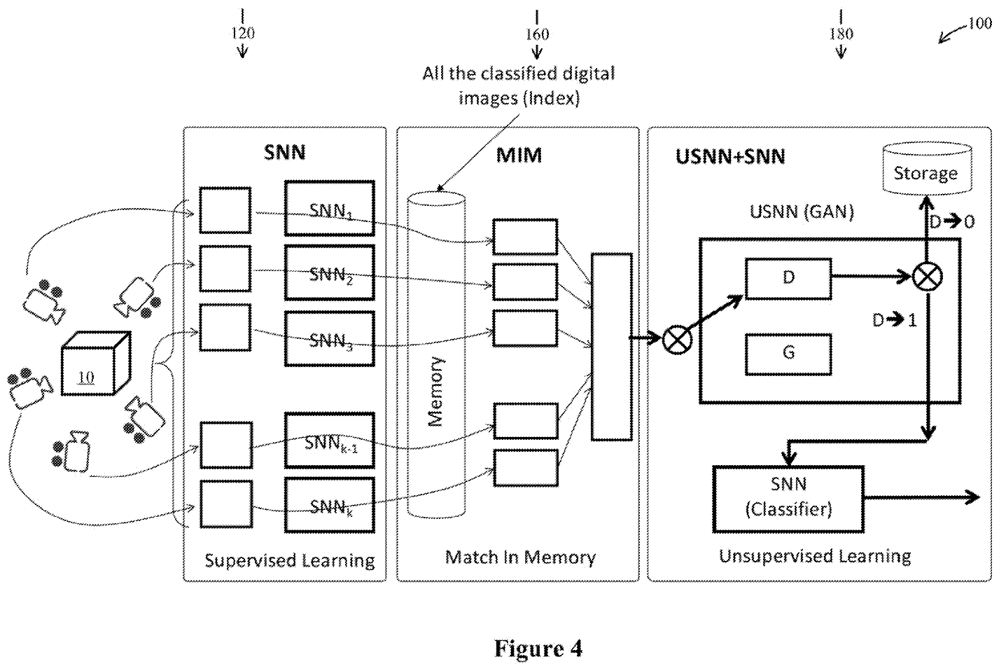

Turning to FIG. 4, the system 100 has three main components, SNN at lower layer 120, MIM in a middle layer 160 and USNN+SNN at upper layer 180. These components can be arranged in different styles to deal with different applications. Some of those applications are presented hereafter.

FIG. 4 illustrates an example system 100, where multiple cameras are deployed in different position to capture an overview of a single object 10 from different angles. The pictures taken can be used as inputs to the system.

The basic version of the system 100 is divided into three main components, multiple Supervised Neural Networks (SNN) at lower layer 120, one Match In Memory (MIM) at the middle layer 160, and Unsupervised Neural Network and Supervised Neural Network (USNN+SNN) at the upper layer 180. Those are the building blocks for more sophisticated AI models, some of which will be given as examples hereafter.

FIG. 5 illustrates an example of a more sophisticated system 100, where, in the same location, there are multiple objects 10a, 10b and 10c that need to be identified. Multiple cameras are deployed around the location of the objects to take pictures of these objects from different angles. The pictures are feed into the SNNs 110 at the low layer 120. In this example, the information from the first top two SNNs 110a and 110b are merged; but the last bottom SNN 110c is kept as standalone.

A first middle layer 130 is introduced to merge the outputs from SNNs 110a and 110b together through MIM 161a, while the output of SNN 110c is normalized using MIM 161b. Then two more layers of USNN and SNN, layers 140 and 150 are introduced to further process the data. MIM 161c then normalizes and merges all the data representation together, to be used as the input for USNN+SNN at upper layer 180, which produces a final out. In this case, the final output may consist of three classifications, one for each object.

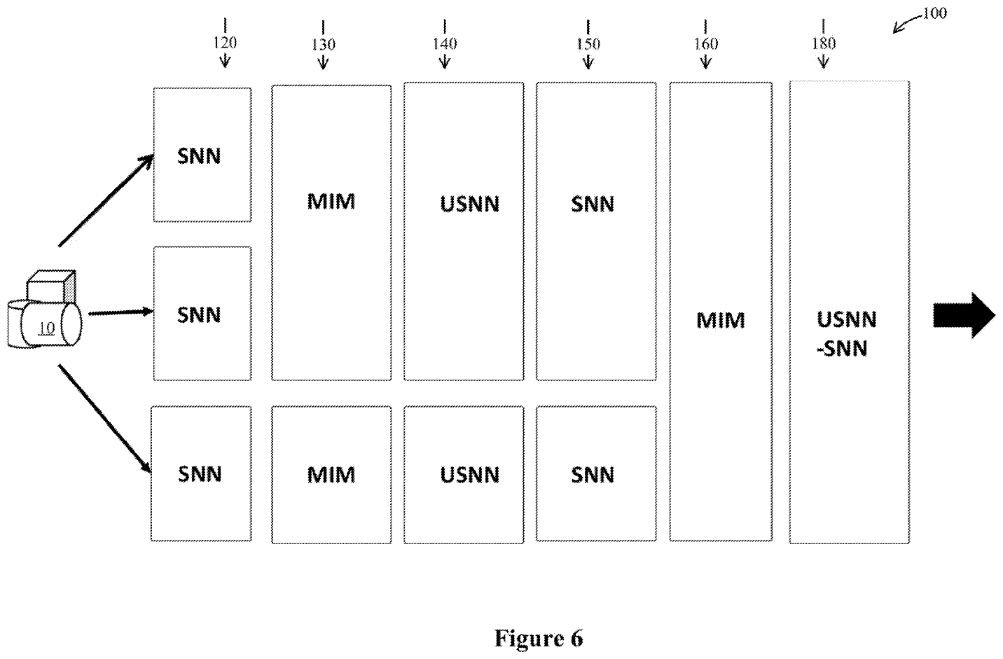

FIG. 6 illustrates an example using the same system configuration as in FIG. 5, where, in the same location, there is a single object 10 having characteristics that need to be identified. Multiple cameras are deployed around the location of the object to take pictures from different angles. The pictures are feed into the SNN at low layer 120. In this example, the information from the first two SNNs are merged; but the last bottom SNN is kept as standalone.

The other middle layers are arranged and work as in FIG. 5. In this case, the final output may consist of one final classification, identifying the object. Alternatively, the final output could consist of three classifications, for three different characteristics of the object.

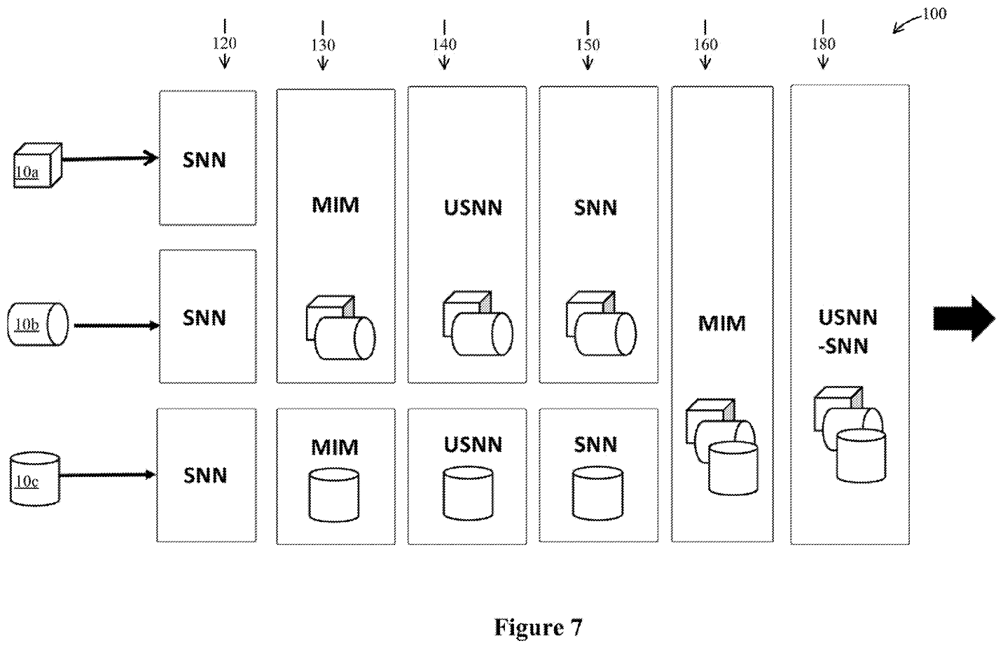

FIG. 7 illustrates an example using the same system configuration as in FIGS. 5 and 6, but in this case there are multiple objects located at different locations. At each location, a camera takes a picture of the local object. Then the pictures are feed into the SNNs at low layer 120. The information from the first two SNNs are merged; but the last one SNN is kept as standalone.

The other middle layers are arranged and work as in FIG. 5, where the top part treats information from two objects 10a and 10b together and the bottom part treats information from object 10c only. Middle layer 160 merges all the data together for use as input for USNN-SNN at upper layer 180. In this case, the final output may consist of one final classification, identifying the reconstructed object. Alternatively, the final output could consist of the identification of the three objects.

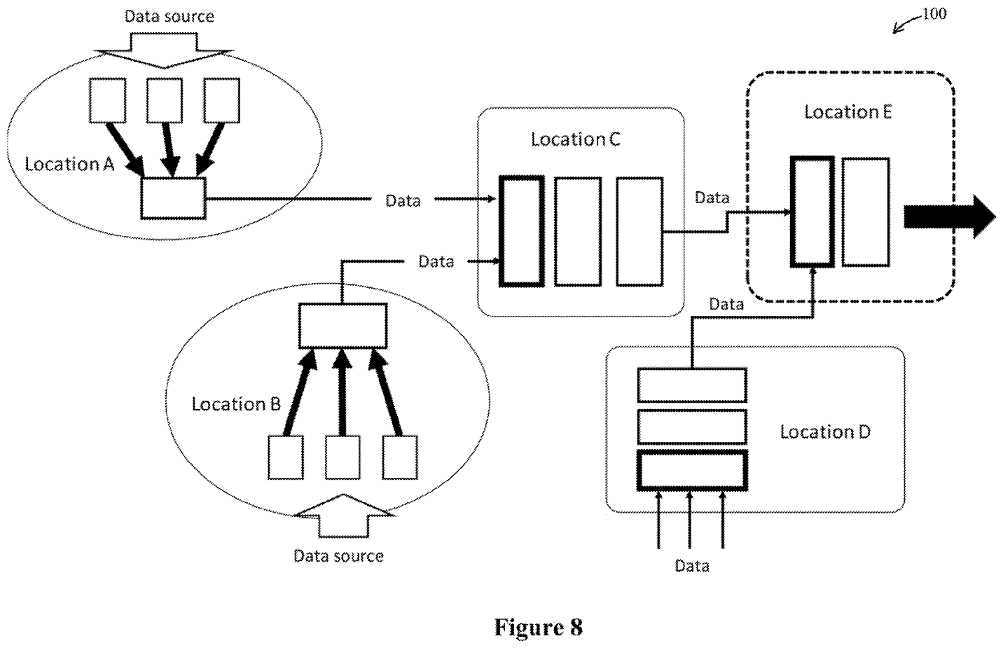

FIG. 8 illustrates an example physical deployment for system 100. This deployment consists of three layers: lower, middle and upper layers.

In this example system 100, two local SNNs are deployed at location A and location B. The output of these two local SNNs are sent to the middle layer residing at location C. Optionally, other data, from SNNs not illustrated, can be merged at another middle layer residing at location D. The data representations at middle layers C and D are re-constructed based on the normalized data distribution (MIM). Eventually the outputs of the MIMs at middle layer are sent to USNN-SNN at the upper layer, which resides at location E.

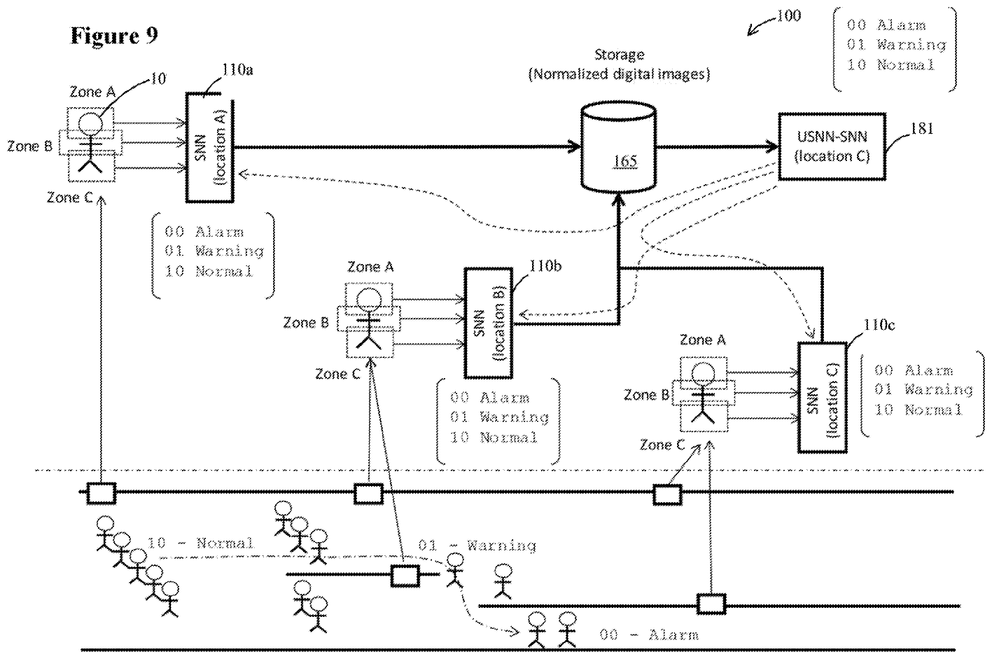

FIGS. 9-11 illustrate a simplified view of an example system 100 that can be used, for example, for airport security. A subject 10 enters the airport and passes through zone A, where at least one camera takes a picture. This picture is fed to the SNN 110a at location A. Not shown is a middle MIM layer associated with location A which normalizes, using storage 165, facial expressions (Zone A), gestures (Zone B) and possibly further gestures or speed of walk (Zone C), which may be indicators of suspect behavior. These normalized features may be fed to a middle USNN-SNN layer at location A, not shown, which outputs an alarm level to be attributed to subject 10, (00 Alarm, 01 Warning and 10 Normal).

In FIG. 9, subject 10 is attributed status normal at location A and can then continue to location B (which may be equipped with MIM and USNN-SNN layers similar to or slightly different from location A) where the same or a similar process is repeated. This time subject 10 is attributed status warning by the system. Subject 10 continues to location C, where it is looked at more closely this time because of previous warning status. Location C may be equipped with MIM and USNN-SNN layers similar to or slightly different from locations A and B and previous warning status may trigger a more thorough check. Again, the same or a similar process is repeated at location C. This time subject 10 is attributed status alarm by the system and can be pulled aside by airport security for additional checks. Alternatively, statuses normal from location A, warning from location B and alarm from location C can be input into another USNN-SNN 181 at location C, which makes the decision that subject 10 should be pulled aside by airport security for additional checks.

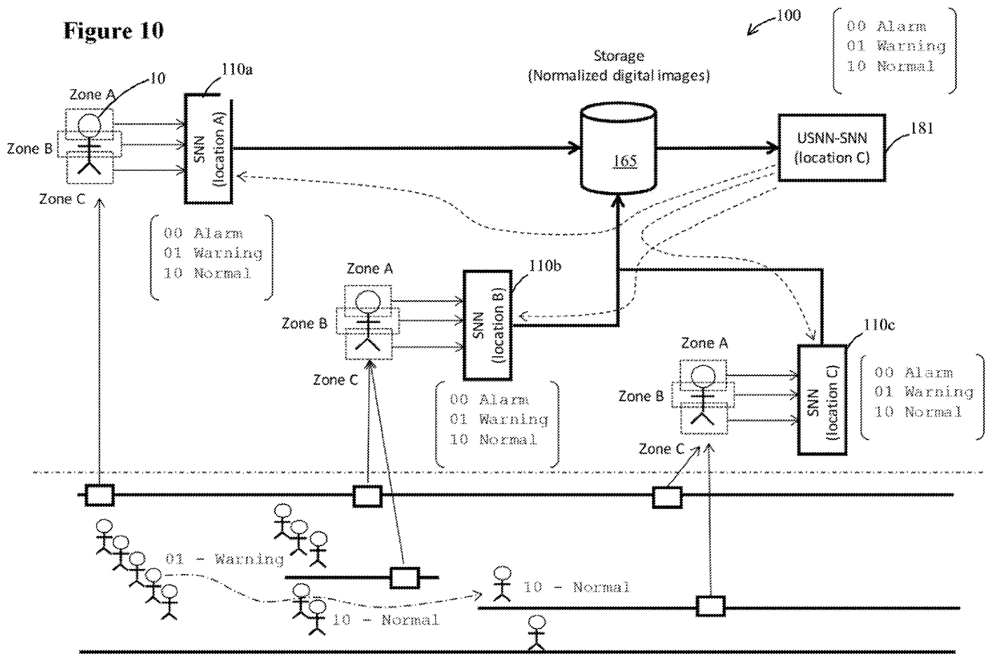

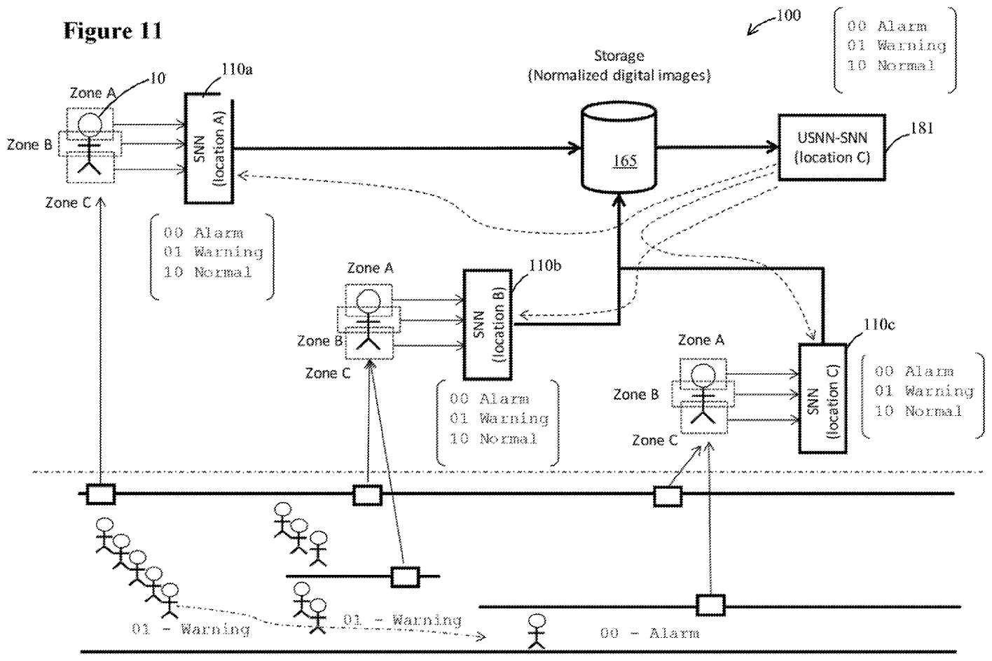

FIGS. 10 and 11 show alternative examples where the status for subject 10 are warning, normal, normal and warning, warning, alarm respectively. Status from a previous location may be used at the next location only, may be used at the next location and at the final location or may only be used at the final location only, depending on system configuration.

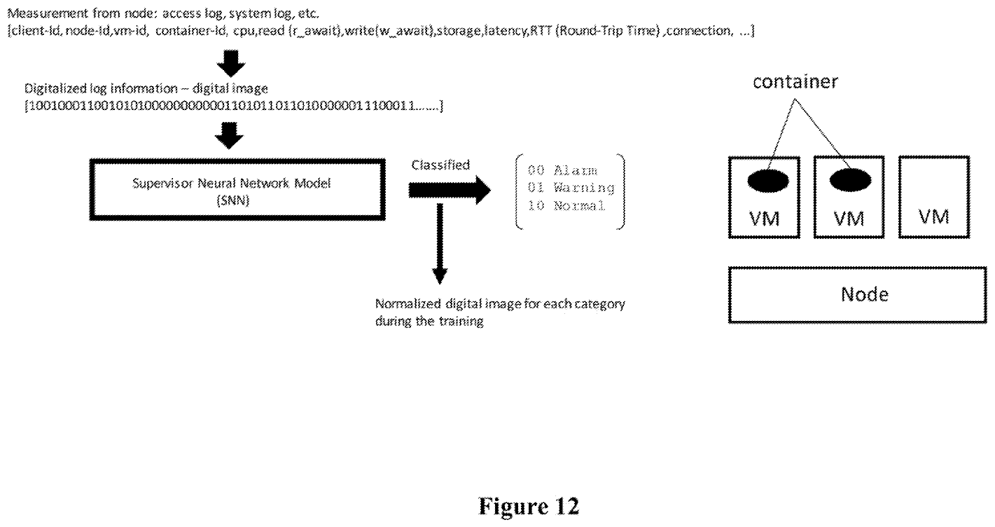

FIGS. 12-14 illustrate a simplified view of an example system 100 that can be used, for example, for monitoring a computer network.

Referring to FIG. 12, the system can monitor the network platform, nodes, virtual machines (VMs), containers as well as network connectivity. Measurements are made on the different hardware and software of the network, and information/data can be read from sources such as, but not limited to access log, system log, and the hardware and software itself. Information can be retrieved such as client identifier, node identifier, VM identifier, central processing unit (CPU) load, read speed, write speed, storage capacity and status, round trim time (RTT), state of connectivity, etc. This data can then be digitalized in a format suitable to be fed to a SNN at lower layer of system 100. From this layer, a classification for the different network elements can be obtained, for example alarm, warning or normal. Digital image in this context refers to a digital representation of data.

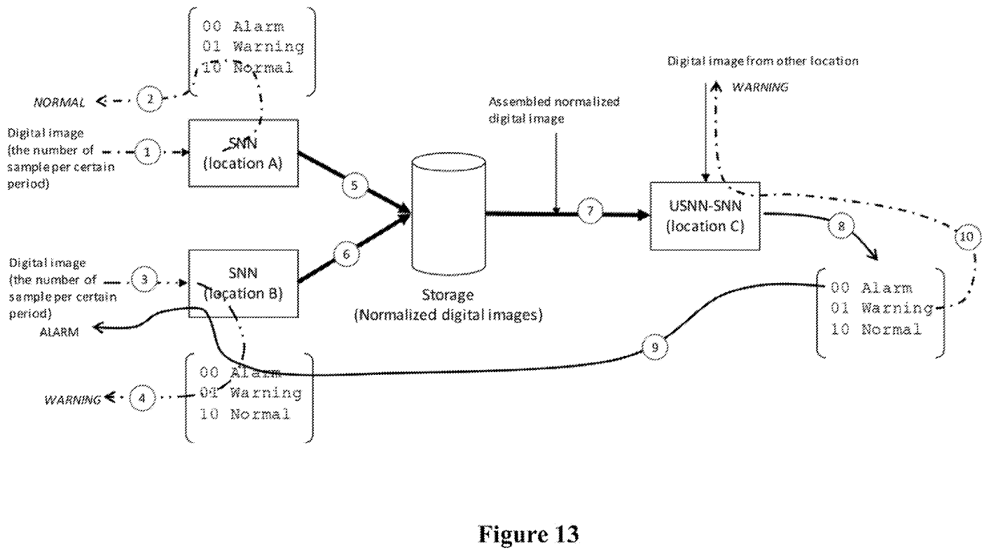

Turning to FIG. 13, at steps 1 and 2, at location A, measurements are made and digitalized. The data is fed to the SNN and a normal status is reported. At steps 3 and 4, at location B, measurement are made and digitalized. The data is fed to the SNN and a warning status is reported. MIM occurs and a normalized digital image (or data representation is extracted) that represents a state of the system is produced at steps 5 and 6 and 7. First the digitalized (normalized) image are retrieved from the storage using the index produced by the SNNs and theses digitalized (normalized) image are assembled at step 7 and can be output towards the USNN-SNN layer. At step 8, after applying USNN-SNN, it is concluded that the status is normal for location A, alarm for location B, warning for location C. At step 9 an alarm status is sent back to location b, where the status is changed from warning to alarm. At step 10, the final status may be sent or saved for further use.

Alternatively, instead of or in addition to determining a status for each location, the system could determine an overall network status.

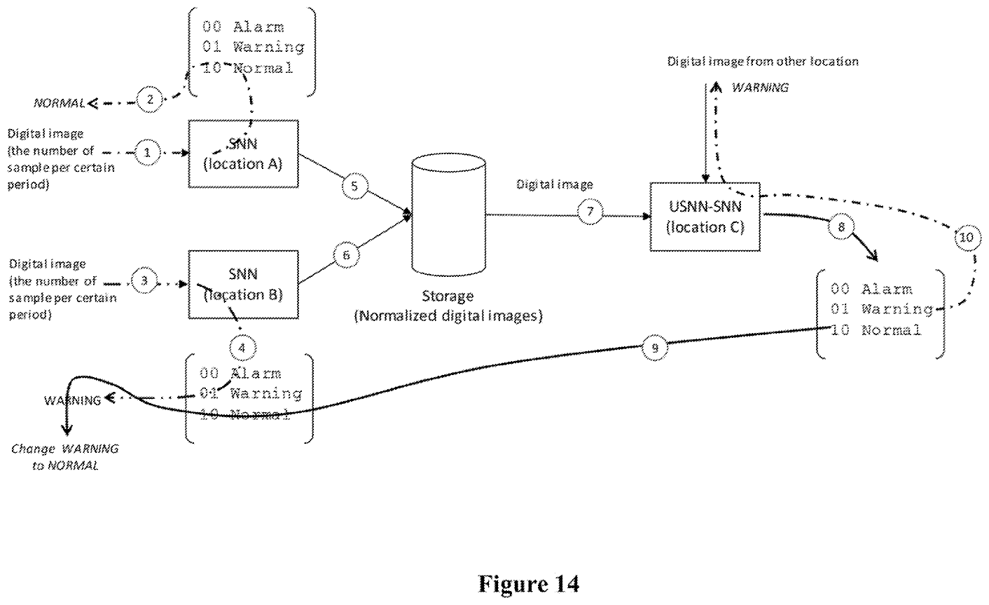

Turning to FIG. 14, steps 1 to 7 are the same as for FIG. 13. However, at step 8, after applying USNN-SNN, it is concluded that the status is normal for location A, normal for location B, warning for location C. At step 9 the normal status is sent back to location b, where the status is changed from warning to normal. At step 10, the final status may be sent or saved for further use.

In the examples of FIGS. 12-14, all the images that are associated to the status that have been changed by the upper USNN-SNN model may be considered for SNN training to enhance the existing SNN models or USNN-SNN model.

In summary, there is provided a system 100 for generating at least one classification based on multiple data sources 105. The system comprises at least one layer 120 comprising one or more supervised neural networks (SNN); at least one layer 180 comprising one or more unsupervised neural networks (USNN); and at least one normalization layer 160. Each of the layers has inputs and outputs, the inputs of a first layer 120 being operative to receive data from the data sources 105, the inputs of a layer other than the first layer 120 being communicatively connected to the outputs of a previous layer, the outputs of a layer other than a last layer 180 being communicatively connected to inputs of a following layer, the last layer 180 having at least one output, and the at least one normalization layer 160 being operative to normalize the outputs from the previous layer into normalized inputs for the following layer.

The system may comprise at least two layers of SNNs. The system may comprise at least two layers of USNNs. The system may comprise at least two normalization layers. The system may comprise three layers, the first layer comprising SNNs, the second layer being a normalization layer and the last layer comprising USNNs and one SNN. The SNN of the last layer may generate the at least one classification using as inputs the outputs of the USNNs. Each SNN and each USNN may have multiple inputs and each SNN and each USNN may have a single output. Each SNN and each USNN may have multiple inputs and at least one of the SNNs and USNNs may have multiple outputs. The normalization layer may normalize the outputs from the previous layer into normalized inputs for the following layer by matching and replacing the outputs from the previous layer with normalized data stored in a data repository 165 accessible by the normalization layer. The normalization layer may combine a subset of the plurality of outputs from the previous layer in to a single normalized input for the following layer. The normalized data stored in the data repository may be computed using a weighted average, an arithmetic computation or a maximum probability function.

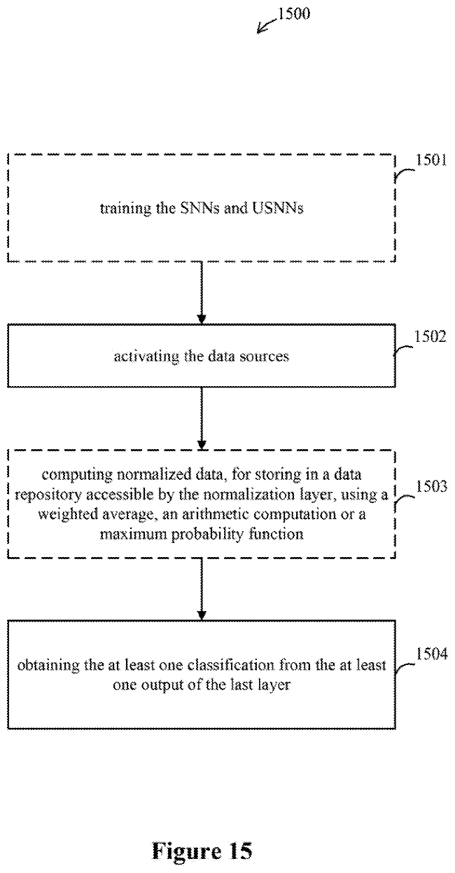

Turning to FIG. 15, there is provided a method 1500 for using a system 100 for generating at least one classification based on multiple data sources 105. The system comprises at least one layer comprising one or more supervised neural networks (SNN) 120; at least one layer comprising one or more unsupervised neural networks (USNN) 180; and at least one normalization layer 160. Each of the layers has inputs and outputs, the inputs of a first layer 120 receiving data from the data sources 105, the inputs of a layer other than the first layer 120 being communicatively connected to the outputs of a previous layer, the outputs of a layer other than a last layer 180 being communicatively connected to inputs of a following layer, the last layer 180 having at least one output, and the at least one normalization layer 160 being operative to normalize the outputs from the previous layer into normalized inputs for the following layer. The method comprises activating, step 1502, the data sources 105; and obtaining, step 1504, the at least one classification from the at least one output of the last layer 180.

The method may further comprise training, step 1501, the SNNs and USNNs. The method may further comprise computing, step 1503, normalized data, for storing in a data repository 165 accessible by the normalization layer, using a weighted average, an arithmetic computation or a maximum probability function. The system executing the method may be according to any one of the systems described herein.

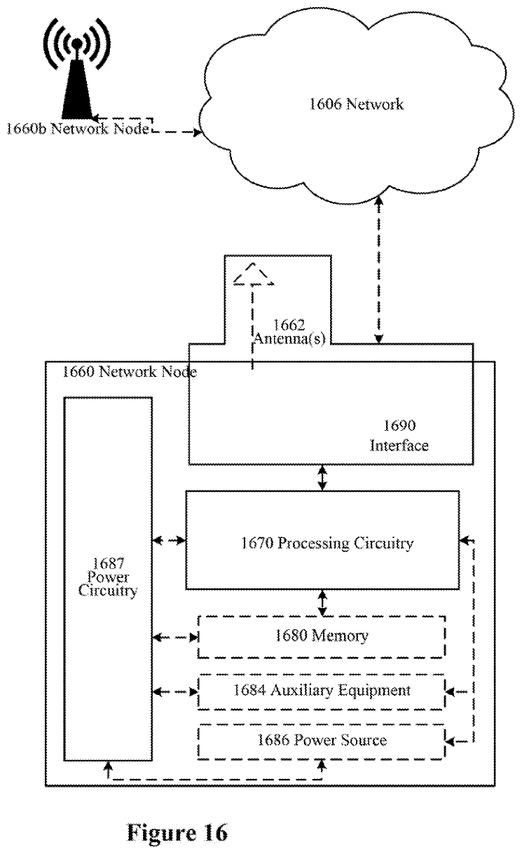

FIG. 16 is a block diagram of a network node 1660 suitable for implementing aspects of the embodiments disclosed herein. In the context of the system 100, the network node 1660 includes a communications interface 1690. The communications interface 1690 generally includes analog and/or digital components for sending and receiving communications within a wireless coverage area of the network node 1660, as well as sending and receiving communications to and from other network nodes 1660b, either directly or via the network 1606, through wired interface or antenna 1662. Those skilled in the art will appreciate that the block diagram of the network node 1660 necessarily omits numerous features that are not necessary for a complete understanding of this disclosure.

Although all of the details of the network node 1660 are not illustrated, the network node 1660 comprises one or several general-purpose or special-purpose processors 1670 or other microcontrollers programmed with suitable software programming instructions and/or firmware to carry out some or all of the functionality of the network nodes 1660. In addition, or alternatively, the network node may comprise various digital hardware blocks (e.g., one or more Application Specific Integrated Circuits (ASICs), one or more off-the-shelf digital or analog hardware components, or a combination thereof) (not illustrated) configured to carry out some or all of the functionality of the network nodes described herein. A memory 1680, such as a random access memory (RAM), may be used by the processor 1670 to store data and programming instructions which, when executed by the processor, implement all or part of the functionality described herein. The network node may also include auxiliary equipment 1684, as well as a power source 1686 and power circuitry 1687. The network node 1660 may also include one or more storage media (not illustrated) for storing data necessary and/or suitable for implementing the functionality described herein, as well as for storing the programming instructions which, when executed on the processor, implement all or part of the functionality described herein. One embodiment of the present disclosure may be implemented as a computer program product that is stored on a computer-readable storage medium, the computer program product including programming instructions that are configured to cause the processor to carry out the steps described herein.

The network node 1660 is operative to generate at least one classification based on multiple data sources, and comprises processing circuitry 1670 and a memory 1680. The memory contains instructions executable by the processing circuitry whereby the network node is operative to host a system comprising at least one layer comprising one or more supervised neural networks (SNN); at least one layer comprising one or more unsupervised neural networks (USNN); and at least one normalization layer. Each of the layers has inputs and outputs, the inputs of a first layer being operative to receive data from the data sources, the inputs of a layer other than the first layer being communicatively connected to the outputs of a previous layer, the outputs of a layer other than a last layer being communicatively connected to inputs of a following layer, the last layer having at least one output, and the at least one normalization layer being operative to normalize the outputs from the previous layer into normalized inputs for the following layer. The network node is further operative to activate the data sources; and obtain the at least one classification from the at least one output of the last layer.

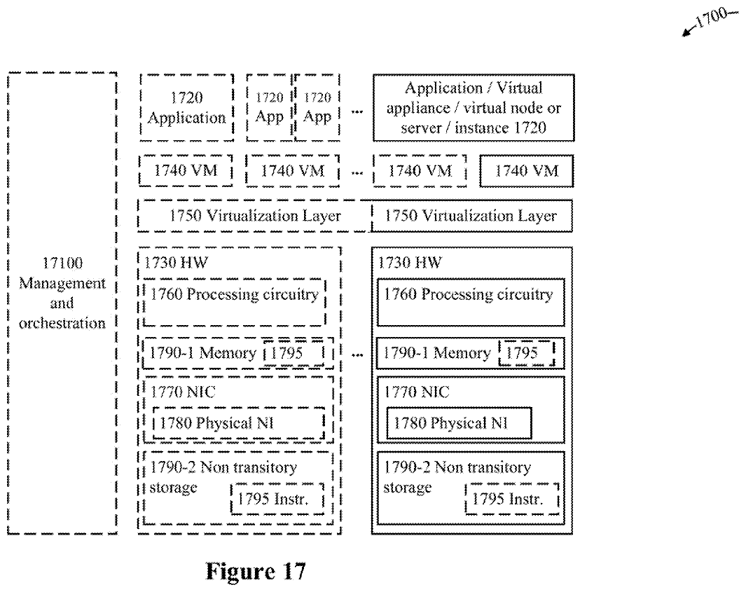

FIG. 17 is a schematic block diagram illustrating a virtualization environment 1700 in which functions implemented by some embodiments may be virtualized. As used herein, virtualization can be applied to a system, or to a node (e.g., a network node) and relates to an implementation in which at least a portion of the functionality is implemented as one or more virtual components (e.g., via one or more applications, components, functions, virtual machines or containers executing on one or more physical processing nodes in one or more networks).

In some embodiments, some or all of the functions described herein may be implemented as virtual components executed by one or more virtual machines or containers implemented in one or more virtual environments 1700 hosted by one or more of hardware nodes 1730. Further, in embodiments in which the virtual node is not a radio access node or does not require radio connectivity (e.g., a core network node), then the network node may be entirely virtualized.

The functions may be implemented by one or more applications 1720 (which may alternatively be called software instances, virtual appliances, network functions, virtual nodes, virtual network functions, etc.) operative to implement steps of some methods according to some embodiments. Applications 1720 run in virtualization environment 1700 which provides hardware 1730 comprising processing circuitry 1760 and memory 1790. Memory 1790 contains instructions 1795 executable by processing circuitry 1760 whereby application 1720 is operative to provide any of the relevant features, benefits, and/or functions disclosed herein.

Virtualization environment 1700, comprises general-purpose or special-purpose network hardware devices 1730 comprising a set of one or more processors or processing circuitry 1760, which may be commercial off-the-shelf (COTS) processors, dedicated Application Specific Integrated Circuits (ASICs), or any other type of processing circuitry including digital or analog hardware components or special purpose processors. Each hardware device may comprise memory 1790-1 which may be non-persistent memory for temporarily storing instructions 1795 or software executed by the processing circuitry 1760. Each hardware devices may comprise one or more network interface controllers 1770 (NICs), also known as network interface cards, which include physical network interface 1780. Each hardware devices may also include non-transitory, persistent, machine readable storage media 1790-2 having stored therein software 1795 and/or instruction executable by processing circuitry 1760. Software 1795 may include any type of software including software for instantiating one or more virtualization layers 1750 (also referred to as hypervisors), software to execute virtual machines 1740 or containers as well as software allowing to execute functions described in relation with some embodiments described herein.

Virtual machines 1740 or containers, comprise virtual processing, virtual memory, virtual networking or interface and virtual storage, and may be run by a corresponding virtualization layer 1750 or hypervisor. Different embodiments of the instance of virtual appliance 1720 may be implemented on one or more of virtual machines 1740 or containers, and the implementations may be made in different ways.

During operation, processing circuitry 1760 executes software 1795 to instantiate the hypervisor or virtualization layer 1750, which may sometimes be referred to as a virtual machine monitor (VMM). Virtualization layer 1750 may present a virtual operating platform that appears like networking hardware to virtual machine 1740 or to a container.

As shown in FIG. 17, hardware 1730 may be a standalone network node, with generic or specific components. Hardware 1730 may implement some functions via virtualization. Alternatively, hardware 1730 may be part of a larger cluster of hardware (e.g. such as in a data center or customer premise equipment (CPE)) where many hardware nodes work together and are managed via management and orchestration (MANO) 17100, which, among others, oversees lifecycle management of applications 1720.

Virtualization of the hardware is in some contexts referred to as network function virtualization (NFV). NFV may be used to consolidate many network equipment types onto industry standard high volume server hardware, physical switches, and physical storage, which can be located in data centers, and customer premise equipment.

In the context of NFV, a virtual machine 1740 or container is a software implementation of a physical machine that runs programs as if they were executing on a physical, non-virtualized machine. Each of virtual machines 1740 or container, and that part of the hardware 1730 that executes that virtual machine, be it hardware dedicated to that virtual machine and/or hardware shared by that virtual machine with others of the virtual machines 1740 or containers, forms a separate virtual network elements (VNE).

Still in the context of NFV, Virtual Network Function (VNF) is responsible for handling specific network functions that run in one or more virtual machines 1740 or containers on top of hardware networking infrastructure 1730 and corresponds to application 1720 in FIG. 17.

There are several advantages associated with the systems method and network node described herein. The concept of “Match In Memory” MIM is used to improve the efficiency and accuracy of the training models. It mimics the memory of human beings. The data distribution at lower layers is considered to be localized and easily classified. Hence the supervised NN is proposed. The data distribution at upper layer is the merge of all the data distribution at lower layers. It has an overview of the target object. This data representation at the upper layer is built on the normalized data representation instead of raw data representation. This mimics the human brain memory function to capture the main local characters of the target object. It should facilitate the recognition/classification of the target object(s). Since an index of the data representation from the classifier is used instead of the actual data representation, the data transferring from lower layer to upper layer is very light. This is very critical for real time processing since the amount of the data transferring within the network is small. The storage at lower layer is used to collect the data for SNN training to enhance the existing model. The storage at the upper layer is used to collect the data for SNN training with a newly added feature in the classifier. The features captured at low layer can be adjusted based on the feedback from the output of USNN-SNN. The system is designed to be flexible for extending the model with the new feature that is identified during the real time data processing. This intelligent system will learn and improved by itself over time.

Modifications and other embodiments will come to mind to one skilled in the art having the benefit of the teachings presented in the foregoing description and the associated drawings. Therefore, it is to be understood that modifications and other embodiments, such as specific forms other than those of the embodiments described above, are intended to be included within the scope of this disclosure. The described embodiments are merely illustrative and should not be considered restrictive in any way. The scope sought is given by the appended claims, rather than the preceding description, and all variations and equivalents that fall within the range of the claims are intended to be embraced therein. Although specific terms may be employed herein, they are used in a generic and descriptive sense only and not for purposes of limitation.

1. A system for generating at least one classification based on multiple data sources, the system comprising:
at least one layer comprising one or more supervised neural networks (SNN);
at least one layer comprising one or more unsupervised neural networks (USNN); and
at least one normalization layer;
each of the layers having inputs and outputs, the inputs of a first layer being operative to receive data from the data sources, the inputs of a layer other than the first layer being communicatively connected to the outputs of a previous layer, the outputs of a layer other than a last layer being communicatively connected to inputs of a following layer, the last layer having at least one output, and the at least one normalization layer being operative to normalize the outputs from the previous layer into normalized inputs for the following layer.

2. The system of claim 1, wherein the system comprises at least two layers of SNNs.

3. The system of claim 1, wherein the system comprises at least two layers of USNNs.

4. The system of claim 1, wherein the system comprises at least two normalization layers.

5. The system of claim 1, wherein the system comprises three layers, the first layer comprising SNNs, the second layer being a normalization layer and the last layer comprising USNNs and one SNN.

6. The system of claim 5, wherein the SNN of the last layer generates the at least one classification using as inputs the outputs of the USNNs.

7. The system of claim 1, wherein each SNN and each USNN has multiple inputs and each SNN and each USNN has a single output.

8. The system of claim 1, wherein each SNN and each USNN has multiple inputs and at least one of the SNNs and USNNs has multiple outputs.

9. The system of claim 1, wherein the normalization layer normalizes the outputs from the previous layer into normalized inputs for the following layer by matching and replacing the outputs from the previous layer with normalized data stored in a data repository accessible by the normalization layer.

10. The system of claim 9, wherein the normalization layer combines a subset of the plurality of outputs from the previous layer into a single normalized input for the following layer.

11. The system of claim 9, wherein the normalized data stored in the data repository is computed using a weighted average, an arithmetic computation or a maximum probability function.

12. A method for using a system for generating at least one classification based on multiple data sources, the system comprising:
at least one layer comprising one or more supervised neural networks (SNN);
at least one layer comprising one or more unsupervised neural networks (USNN); and
at least one normalization layer;
each of the layers having inputs and outputs, the inputs of a first layer receiving data from the data sources, the inputs of a layer other than the first layer being communicatively connected to the outputs of a previous layer, the outputs of a layer other than a last layer being communicatively connected to inputs of a following layer, the last layer having at least one output, and the at least one normalization layer being operative to normalize the outputs from the previous layer into normalized inputs for the following layer; and
the method comprising:
activating the data sources; and
obtaining the at least one classification from the at least one output of the last layer.

13. The method of claim 12, further comprising training the SNNs and USNNs.

14. The method of claim 13, further comprising computing normalized data, for storing in a data repository accessible by the normalization layer, using a weighted average, an arithmetic computation or a maximum probability function.

15. (canceled)

16. A network node operative to generate at least one classification based on multiple data sources, comprising processing circuitry and a memory, the memory containing instructions executable by the processing circuitry whereby the network node is operative to host a system comprising:
at least one layer comprising one or more supervised neural networks (SNN);
at least one layer comprising one or more unsupervised neural networks (USNN); and
at least one normalization layer;
each of the layers having inputs and outputs, the inputs of a first layer being operative to receive data from the data sources, the inputs of a layer other than the first layer being communicatively connected to the outputs of a previous layer, the outputs of a layer other than a last layer being communicatively connected to inputs of a following layer, the last layer having at least one output, and the at least one normalization layer being operative to normalize the outputs from the previous layer into normalized inputs for the following layer;
the network node being further operative to:
activate the data sources; and
obtain the at least one classification from the at least one output of the last layer.

17. (canceled)
